(19) United States
(12) Patent Application Publication
(10) Pub. No.: US 2006/0031560 A1
(43) Pub. Date: Feb. 9, 2006

(54) Method and system for transferring a file between data processing devices using a communication or instant messaging program

(76) Inventors: Seth Warshavsky, Prathumwan (TH); Timon Haringa, Bangkrak (TH)

Correspondence Address: ERIC ROBINSON, PMB 955, 21010 SOUTHBANK ST., POTOMAC FALLS, VA, 20165, US

(21) Appl. No.: 10/879,504

(22) Filed: Jun. 30, 2004

(51) Int. Cl. G06F 15/16

(52) U.S. Cl. 709/232

(57) ABSTRACT

A method having steps of transferring a file from a first data processing device to a third data processing device, transmitting a reference from the first device to a second data processing device using a communication program, and accessing the file on the third device from the second device using the reference. Also, a system having a first data processing device operable to be in communication with a second data processing device using a communication program, and a computer program operable to transfer a file from the first device to a third data processing device, where the computer program is operable to transmit a reference from the first device to the second device using the communication program, and where the file on the third device may be accessed from the second device using the reference. The communication program may be an instant messaging program.

### FIELD OF THE INVENTION

The present invention generally relates to the transmission and reception of data in an instant messaging environment and more particularly to a system and method for file transfer between two data processing devices during a communication exchange, for example, during an instant message exchange.

### BACKGROUND OF THE INVENTION

As data connectivity between computing devices has become ubiquitous, various communications applications are routinely used by users to communicate between one another. One such type of communications application is an instant messaging system, such as AOL Instant Messenger, MSN Messenger, or the like. Such systems generally alert a user when friends, family or colleagues (usually contained in a so-called “buddy list”) go on-line for the real-time exchange of messages. Instant messaging is cheap, with most providers of such communications applications having no fee for the use of the software. It is also powerful, allowing users to communicate in real-time while, for example, reviewing information using another application on their computer system. It further provides immediate notification of the availability of colleagues so that it is unnecessary to waste time trying to contact them when they are otherwise unavailable.

One of the best known instant messaging systems is America Online's Instant Messenger (AIM) that was originally designed as a feature for AOL's pay service. AIM is software that anyone with an Internet connection can download, whether they are an AOL member or not. After registering a screen name, the user can maintain lists of AOL members and other AIM users, and be alerted whenever one of those in the so-called buddy list is available on-line. When a person in the buddy list comes on-line, the corresponding screen name appears in an AIM interface window on the screen. By clicking on the name appearing in the AIM interface window, the user may then send an instant message and initiate a conversation session. Users can also sort the buddy list into groups. As noted above, other vendors, such as MSN, Yahoo, and Mirabilis (ICQ) offer similar instant message services.

With the increase in mobile data processing devices that operate using one or more wireless networks, instant messaging application software has also become available for a number of wireless devices. In such case, instant messages are transferred to and from the wireless device is a fashion similar to that used to transfer such messages between wired devices. With the development of these instant messaging applications, instant messaging across wireless devices has become seamless. Furthermore, many wireless devices are now equipped with input devices to permit the capture of audio, images, video and other data. Such wireless devices also include the ability to transfer such content to other users, usually using a proprietary data transmission system.

In an instant messaging session, when a conversation session is initiated, each user of the instant messaging software may type text that is transferred and displayed to the other party. Such exchange of typed text is often referred to a “chat” between the parties. One drawback of such system is the need to type text to each other and the limitations that such form of written communication places on the parties. For example, images, audio, video, multimedia, and other files are not readily transferred during a conversation, or chat, session. To mitigate these problems, some instant messaging applications have provided a file transfer capability. In such case, a first user generally invokes the file transfer feature and selects a file to be transferred to the other, second, party. The instant messaging application then establishes a connection between the first and second party and transfers the file from the first, sending, party to the second, receiving party. Such a file transfer process is sometimes referred to as a “direct connection” since the file may be transferred directly between the first and second parties albeit using a data transmission protocol different from that used to transfer typed text in the chat session. The received file may then be displayed or saved on the data processing device of the second, receiving, party as appropriate.

Such file transfer method, however, has significant limitations. First, if an interruption during the data transmission process occurs, the file transfer can fail and would need to be reinitiated. When the file to be transferred is a multimedia file, audio, or video file, the file size can be large making the file transfer process frustrating and difficult to use. Such problems are highlighted when one or both of the users is operating a mobile device wherein the data transmission capabilities may fluctuate. Second, the file transmission is usually limited to a single receiving party and if multiple parties need to receive the same file, multiple transmission sessions must be initiated. As a result, the same file, which may be quite large, must be transmitted by the sending party repeatedly. Where the sending party is using a mobile device, the data throughput (bandwidth) and capacity may be limited and such multiple transmission may be expensive.

Thus, there exists a need for a more reliable and more efficient system and method for the transfer of files, such as audio, video, multimedia files and the like, between parties of an instant messaging chat session.

### SUMMARY OF THE INVENTION

The present invention is directed to a system and method for transferring a data file from a first data processing device to a second data processing device in an instant messaging environment. In accordance with the present invention, the data file is transferred from a first, sending, party to a third data processing device and a reference to the file, such as a uniform resource locator or URL, is transferred from the first, sending, party to the second, receiving, party using an instant messenger application. Upon receipt of the reference by the second, receiving, party, the user of the second data processing device can access the file content on the third data processing device using the reference.

It is an object of the present invention to facilitate the transfer of a data file from a first party to a second party in an instant messaging environment in which an instant messaging session is established between the first and second party.

It is a further object of the present invention to facilitate such file transfer by providing a third data processing device that receives the data file from the first party and stores the data file for access by the second party.

It is yet another object of the present invention to provide a system and method for transferring a data file in which a reference or link to the data file to transferred from a first, sending, party to a second, receiving, party.

It is a further object to provide such a system and method wherein the reference or link is a URL or universal resource locator.

It is another object of the present invention to provide a system and method to transfer a data file from a first data processing device to a second data processing device wherein the data file is transferred from the first data processing device to a third data processing device using a first communication path and a link or reference to the data file on the third data processing device is transferred from the first data processing device to the second data processing device using a second communication path.

It is still a further object of the present invention to provide a system and method for transferring a data file between parties engaged in an instant messaging connection wherein a reference or link to the data file is transmitted using said instant messaging connection.

It is a further object of the present invention to transfer an audio file from a first user of an instant messaging application to a second user of an instant messaging application.

It is yet a further object to transfer such audio file wherein the first user is a mobile user operating a wireless mobile device.

It is a still further object to facilitate the transfer of such audio file wherein the wireless mobile device includes a push-to-talk functionality and the audio file is transferred to a third data processing device using the available push-to-talk functionality.

These and other objects of the present invention will become readily apparent upon further review of the following specification and drawings.

### BRIEF DESCRIPTION OF THE DRAWINGS

FIG. 1 is a diagrammatic view of one embodiment of a system of the present invention.

FIG. 2 is a diagrammatic view of another embodiment of a system of the present invention.

FIG. 3 is a flow chart of one embodiment of a method of the present invention.

FIG. 4 is a flow chart of another embodiment of a method of the present invention.

FIG. 5 is a flow chart of still another embodiment of a method of the present invention.

Similar reference characters denote corresponding features consistently throughout the attached drawings.

### DETAILED DESCRIPTION OF THE PREFERRED EMBODIMENTS

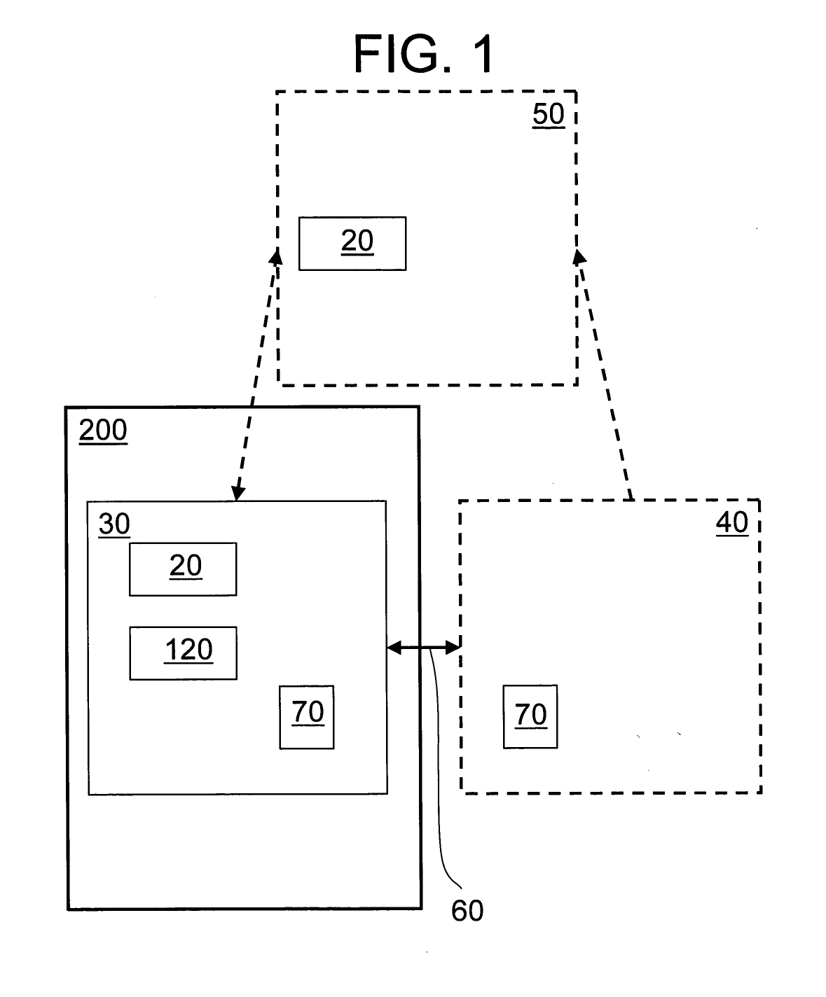

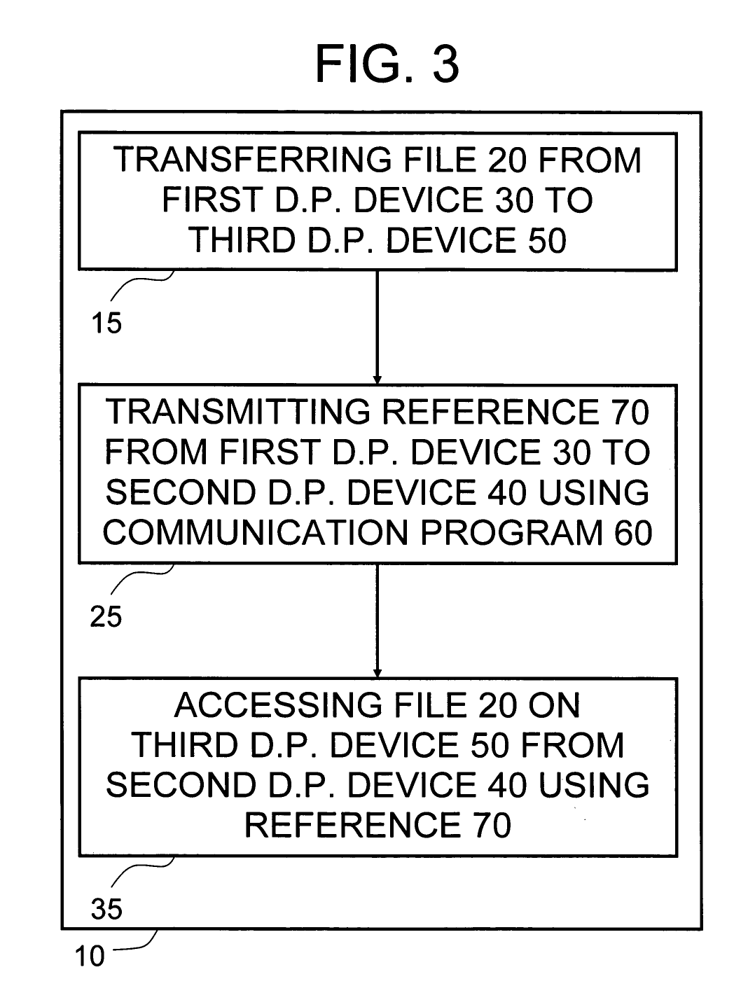

As shown in FIGS. 1 and 3, one preferred embodiment of the present invention is directed to a method 10 for transferring a file 20 from a first data processing device or a first computer 30 to a second data processing device or a second computer 40 by means of a third data processing device or a third computer 50, the first data processing device 30 being in communication with the second data processing device 40 using a communication program 60. The method 10 may comprise transferring 15 the file 20 from the first data processing device 30 to the third data processing device 50, transmitting 25 a reference 70 from the first data processing device 30 to the second data processing device 40 using the communication program 60, and accessing 35 the file 20 on the third data processing device 50 from the second data processing device 40 using the reference 70.

The communication program 60 may be any suitable communication program for transferring data between the first data processing device or first computer 30 and the second data processing device or second computer 40. In accordance with a preferred embodiment of the present invention, communication program 60 is an instant messaging program 80. The instant messaging program 80 may be any one or more MSN Messenger, AOL Instant Messenger (AIM), Yahoo! Messenger and ICQ, or any other suitable instant messaging program or programs.

In accordance with the present invention, a first user of a first data processing device 30 engaged in an instant messaging connection with a second user of a second data processing device 40 may initiate a data file transfer from the first data processing device 30 to the second data processing device 40. In such case, the first data processing device 30 first transfers the desired data file to a third data processing device 50. Third data processing device 50 may be a data server connected to a global network of computers, such as the internet and may be adapted to provide access to data stored therein using a standard internet compatible protocol, such as TCP/IP. Content on data processing device 50 may be referenced using a reference or link, commonly known as a URL or uniform resource locator. Thus, any computer or data processing device having access to data processing device 50 and having knowledge of the URL, may request the content from data processing device 50. Following transfer of data file from the first data processing device 30 to the third data processing device 50, the first data processing device 30 transfers such a link or reference to the second data processing device 40 using the instant messaging connection. The second data processing device 40 then uses the information contained in the link or reference to access the data file from the third data processing device 50.

The transfer of the data file from the first data processing device 30 to the third data processing device 50 may be made using any suitable data connection. Such data connection may include, for example, a standard TCP/IP data connection path or may be any one of a proprietary data connection path. Furthermore, first data processing device 30 may be a wireless device, such as a mobile phone or personal computer, and the connection path from the first data processing device 30 and the third data processing device 50 may be a wireless data communication link using a standard or proprietary data transfer protocol.

In one preferred embodiment of the present invention, first data processing device 30 may be a wireless phone having a push to talk functionality that permits first data processing device 30 to directly transfer a short audio message to another user of a similar data processing device. Such capability is commercially offered in the United States through providers such as Nextel and their direct-connect walkie-talkie service, but requires the use of a proprietary network to transfer such audio file. In accordance with the present invention, where a user of such service wishes to send a similar audio message to a user having only a standard data network connection, such as a TCP/IP internet connection, the resulting audio file can be transferred using a service provider's proprietary network to a third data processing system 50 and a reference or link to such third data processing device may be transferred from the first data processing device to the user having only a standard data network connection.

The first data processing device 30 may further comprise a computer program 120 for managing file transfer and reference transmission, as appropriate. In accordance with the present invention, the computer program 120 may create the reference or link 70 to the file 20 and transfer such reference or link 70 to second data processing device 40, or such reference or link 70 may be generated by the third data processing device 50 subsequent to receipt of the data file 20 from the first data processing device 30 and returned from the third data processing device 50 to the first data processing device 30.

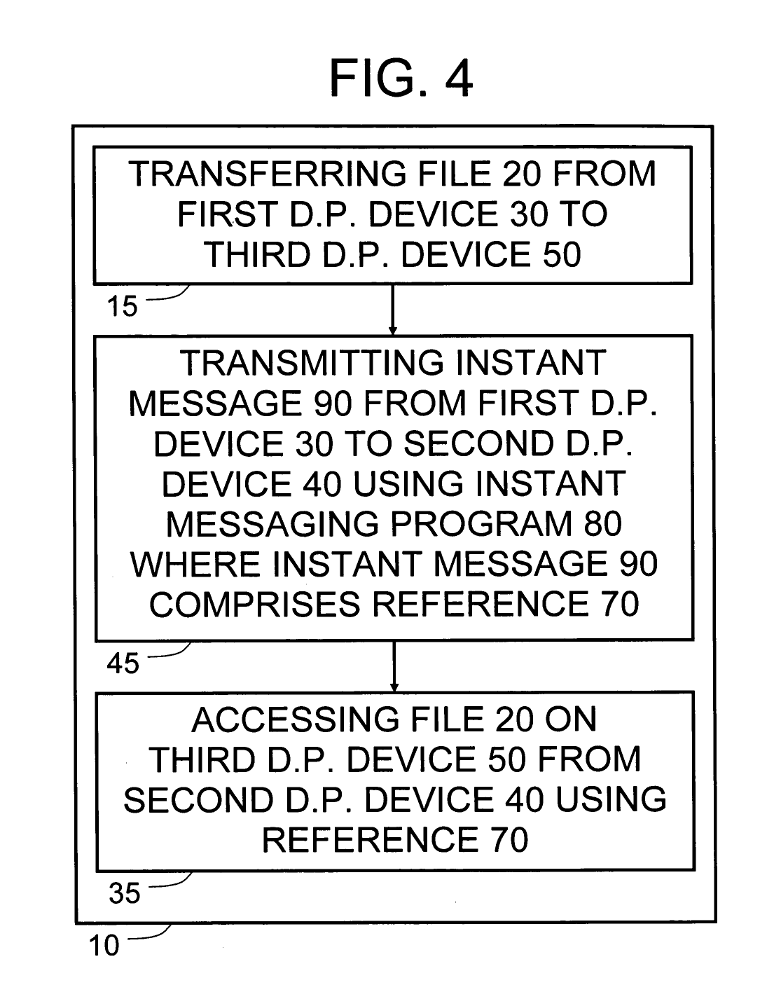

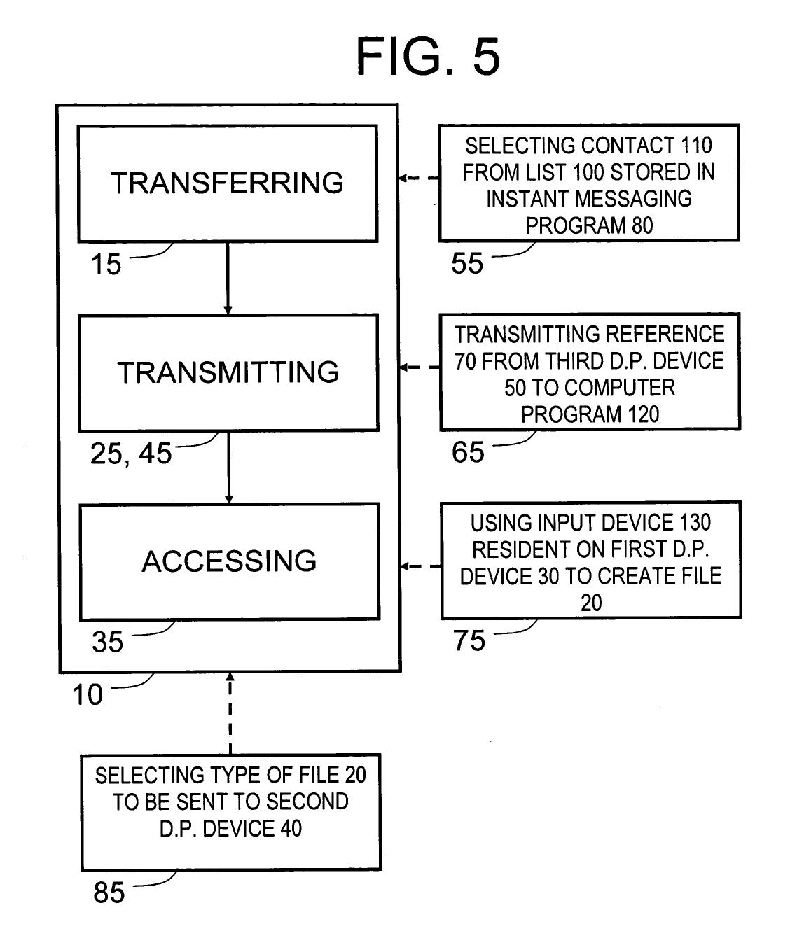

As shown in more detail in FIGS. 4 and 5, the method 10 may further comprise additional steps 45, 55, 65, 75 and 85, which are described in greater detail below. One or more of the additional steps 45, 55, 65, 75 and 85 may be implemented in the method 10 in any suitable order.

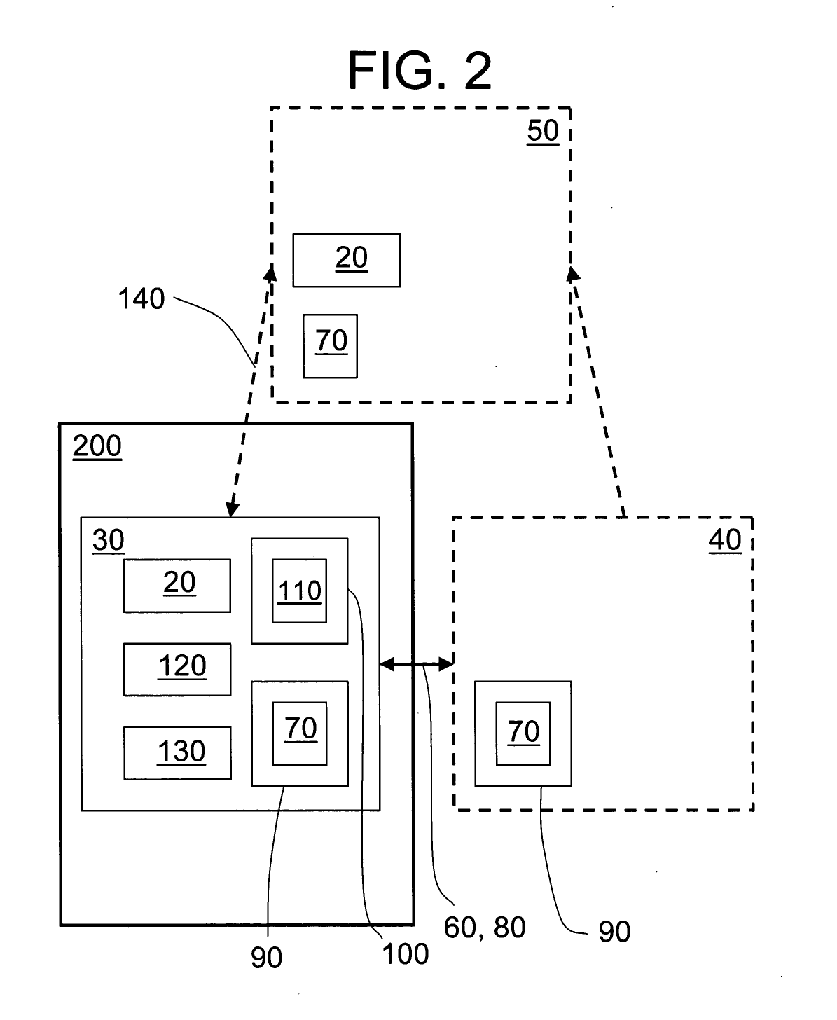

As shown in FIGS. 2, 4 and 5, the method 10 may further comprise transmitting 45 an instant message 90 from the first data processing device 30 to the second data processing device 40 using the instant messaging program 80, where the instant message 90 comprises the reference or link 70. In accordance with a preferred embodiment of the present invention, the transfer of a data file between a first data processing device 30 and a second data processing device 40 that are engaged in an instant messaging connection is facilitated through the use of the third data processing device 50. In accordance with the present invention, it is not necessary to establish a direct data communication path between the first data processing device 30 and the second data processing device 40 to transfer the data file 20. Instead, the data file 20 is transferred from the first data processing device 30 to the third data processing device 50 using any suitable data communication path and a reference or link 70 to the data file 20 on the third data processing system 50 is transferred from the first data processing device 30 to the second data processing device 40 to permit the second data processing device 40 to access the data file 20 on the third data processing device 50 using any suitable data communication path.

In accordance with the present invention, access to the data file 20 by the second data processing system 40 may be limited with appropriate security access features such as a password or other authentication means. Furthermore, access may be unrestricted to permit a plurality of second data processing devices 40 to access the data file 20 on the third data processing system 50. In this way, it is only required that the first data processing system 30 transfer the data file 20 a single time to the third data processing system 50 and thereafter may transmit multiple references or links to a plurality of second data processing devices 40. As will be readily understood to those of skill in the art, such functionality is particular useful where the first data processing device 30 is a wireless device or other device that has limited data communications capabilities. In such case where data transfer may be limited by speed or cost, it is more efficient to transfer the data file 30 (which may include audio, video, image or other information that makes data file 20 relatively large) a single time to the third data processing device 50 and to thereafter transfers multiple references or links (which are relatively short, text based messages) to one or more second data processing devices 40. Using a more reliable, high speed data communication path, the one or more second data processing devices 40 may thereafter access the data file 20 from the third data processing system 50.

The data file 20 may be retained on the third data processing system for any period of time determined to be suitable. Thus, the data file may be retained only for a short period of time to permit a single access by the second data processing system 40, or may be retained for a longer period to permit multiple accesses of the file by one or plural second data processing systems 40. Furthermore, as will be readily understood, the reference or link to the data file 20 need not only be received by the second data processing system 40 from the first data processing system 30, but may be received from any other party using any suitable communication system. Thus, a user of the second data processing system 40 may share the reference or link to the data file 20 with other users, subject to any appropriate security measures, to further facilitate the transfer of data file 20.

As shown in FIGS. 2 and 5, the method 10 may further comprise selecting 55 a contact 110 from a list 100 stored in the instant messaging program 80. Contact 110 may be any user name or pseudonym contained in a so-called buddy list 100 and stored in the first data processing device 30. Thus, a user of the first data processing device may select a recipient or contact 110 for a data file transfer using the available list 100 provided with the installed instant messaging software.

As shown in FIGS. 2 and 5, the method 10 may further comprise transmitting 65 the reference or link 70 from the third data processing device 50 to the computer program 120. That is, the reference or link 70 may be generated either by the first data processing device 30 at the time that the data file 20 is transferred to the third data processing device 50. Alternatively the reference or link 70 may be generated by the third data processing device 50 upon receipt of the data file 20 from the first data processing device 30. In such case, in accordance with one preferred embodiment of the present invention, the third data processing device 50 would return the reference or link 70 to the first data processing device 30 using the same communication path that was used to transfer the data file to the third data processing device 50.

As shown in FIGS. 2 and 5, the method 10 may further comprise using 75 an input device 130 resident on the first data processing device 30 to create the file 20. The input device 130 may be an audio input device such as a microphone, an image input device such as an image camera, a video input device such as a video camera, a device which combines these functions, or the like. As is readily apparent to those of skill in the art, with the convergence of audio, image, video and the like functionality into a single mobile device, there exists a need to transfer such content from the mobile device to others, such as users of the second data processing device 40. In many instances, however, the transfer of such content is limited by the proprietary network of a service provider that supports the mobile device. In accordance with the present invention, such content can be easily made available to any user having a standardized data connection through the use of the third data processing device 50.

The file 20 may be a multimedia file, such as an audio file, an image file, a video file, a combination of the same, or the like.

As shown in FIGS. 1 and 5, the method 10 may further comprise selecting 85 a type of the file 20 to be sent to the second data processing device 40, where the type may be an audio file, an image file, a video file, a combination of the same, or the like.

The first data processing device 30 may be a mobile device, such as a mobile phone, a personal digital assistant (PDA), a hybrid mobile phone/PDA, a laptop, a tablet computer, a webpad, a handheld computer, and a wearable computer.

The computer program 120 may be adapted to function with a device such as a Symbian device, a Symbian Series 60 device, a Symbian UIQ device, a Microsoft Smartphone, a Microsoft Pocket PC device, a Palm OS 3.5+ device, a Java ME device, a J2ME device, a BREW device, a WAP enabled device, or the like.

The computer program 120 may further comprise support for instant messaging functions. Specifically, the messenger client software may send and receive instant messages to and from all supported instant messaging programs, on an individual or group basis. The messenger client software may be adapted so that users can create groups of contacts from different instant messaging services and distribute text messages, picture messages and push to talk messages to the whole group in a single action.

The computer program 120 may further comprise support for push to talk over internet protocol (IP), which may be used in a handset-to-handset mode or in a handset to PC mode. The user may select a contact, press a button and talk. Forwarding is started and the message is streamed to a recipient's device when the user starts talking. If the recipient is a PC user, then an HTTP URL link may be sent, which can be used by the recipient to hear the message. OMA standards may be implemented.

The computer program 120 may further comprise support for picture messaging and camera support, which may be used in a handset-to-handset mode or in a handset to PC mode. The user may capture an image from a handset camera and the computer program 120 may transport the image to another handset. If the recipient is a PC user, then an HTTP URL link may be sent, which can be used by the recipient to view the image.

The computer program 120 may further comprise support for multi-lingual Unicode or BIG5.

The computer program 120 may further comprise support for concurrent connections to instant messaging services. The computer program 120 may support simultaneous connections to multiple instant messaging services.

The computer program 120 may further comprise support for multiple simultaneous conversations.

The reference 70 may be a hyperlink, a uniform resource locator (URL), hyper text transfer protocol (HTTP) code, or the like.

As shown in FIG. 2, the third data processing device 50 may be connected to the first data processing device 30 through a wireless network, an internet connection, or the like 140.

The present invention is also directed to a system 200 for transferring a file 20 to a second data processing device 40 by means of a third data processing device 50, the system comprising a first data processing device 30 operable to be in communication with the second data processing device 40 using a communication program 60, and a computer program 120 operable to transfer the file 20 from the first data processing device 30 to the third data processing device 50, where the computer program 120 may be operable to transmit a reference 70 from the first data processing device 30 to the second data processing device 40 using the communication program 60, and where the file 20 on the third data processing device 50 may be accessed from the second data processing device 40 using the reference 70. The system may further comprise features which are similar to those described in the method 10 above.

In another embodiment of the present invention, a sender uses a method 10 where the sender of a file 20, such as a multimedia file, uses a first data processing device 30, such as a mobile device, with a computer program 120, such as messenger client software, installed on the first data processing device 30 where the first data processing device 30 has access to a network 140, such as the internet.

A recipient uses a second data processing device 40, such as a personal computer, with a communication program 60, such as an instant messaging program 80, installed on the second data processing device 40, where the communication program 60 is supported by the computer program 120. Examples of the instant messaging program 80 include MSN Messenger, AOL Instant Messenger (AIM), Yahoo! Messenger, ICQ, Jabber and QQ, but any other type of communication program 60 may be used with the computer program 120.

To transfer the file 20, the user of the first data processing device 30 may first select a contact 110 on a list 100 stored in the instant messaging program 80, then select a type of the file 20 to be sent, then creates a new file 20 or selects an existing file 20 stored on the first data processing device 30, and then initiates a file transfer.

The file 20 may be uploaded from the first data processing device 30 to a third data processing device 50, such as a messenger server or an internet server. The third data processing device 50 creates a reference 70, such as an HTTP URL, to the uploaded file 20 and replies to the computer program 120 reporting the reference 70 to the newly uploaded file 20. The computer program 120 then sends an instant message 90 to the selected contact 110. The recipient of this instant 90 message will receive the reference 70 to the file 20 and can then see or hear the sent file 20 using software for accessing the file 20, such as a web browser.

It is to be understood that the present invention is not limited to the sole embodiments described above, but encompasses any and all embodiments within the scope of the following claims.

We claim:

1. A method for transferring a file from a first data processing device to a second data processing device by means of a third data processing device, the first data processing device being in communication with the second data processing device using a communication program, the method comprising:
transferring the file from the first data processing device to the third data processing device,
transmitting a reference from the first data processing device to the second data processing device using the communication program, and
accessing the file on the third data processing device from the second data processing device using said reference.

2. The method of claim 1, wherein the communication program is an instant messaging program.

3. The method of claim 2, wherein said instant messaging program is one from the group consisting of MSN Messenger, AOL Instant Messenger (AIM), Yahoo! Messenger and ICQ.

4. The method of claim 2, wherein the method further comprises transmitting an instant message from the first data processing device to the second data processing device using said instant messaging program, wherein said instant message comprises said reference.

5. The method of claim 2, wherein the method further comprises selecting a contact from a list stored in said instant messaging program.

6. The method of claim 2, wherein the first data processing device further comprises a computer program for managing said file transfer and said reference transmission.

7. The method of claim 6, wherein said computer program creates said reference to the file.

8. The method of claim 7, wherein the method further comprises transmitting said reference from the third data processing device to said computer program.

9. The method of claim 2, wherein the method further comprises using an input device resident on the first data processing device to create the file.

10. The method of claim 9, wherein the input device is one selected from the group consisting of an audio input device, an image input device, and a video input device.

11. The method of claim 9, wherein the input device is one selected from the group consisting of a microphone, an image camera and a video camera.

12. The method of claim 2, wherein the file is a multimedia file.

13. The method of claim 2, wherein the file is one selected from the group consisting of an audio file, an image file, and a video file.

14. The method of claim 2, wherein the method further comprises selecting a type of the file to be sent to the second data processing device.

15. The method of claim 2, wherein the type is one selected from the group consisting of an audio file, an image file, and a video file.

16. The method of claim 2, wherein the first data processing device is a mobile device.

17. The method of claim 16, wherein said mobile device is one selected from the group consisting of a mobile phone, a personal digital assistant (PDA), a hybrid mobile phone/PDA, a laptop, a tablet computer, a webpad, a handheld computer, and a wearable computer.

18. The method of claim 6, wherein said computer program is adapted to function with a device selected from the group consisting of a Symbian device, a Symbian Series 60 device, a Symbian UIQ device, a Microsoft Smartphone, a Microsoft Pocket PC device, a Palm OS 3.5+ device, a Java ME device, a J2ME device, a BREW device, and a WAP enabled device.

19. The method of claim 6, wherein said computer program further comprises support for push to talk over internet protocol (IP).

20. The method of claim 6, wherein said computer program further comprises support for picture messaging and camera support.

21. The method of claim 6, wherein said computer program further comprises multi-lingual Unicode support.

22. The method of claim 6, wherein said computer program further comprises support for concurrent connections to instant messaging services.

23. The method of claim 6, wherein said computer program further comprises support for multiple simultaneous conversations.

24. The method of claim 2, wherein said reference is one selected from the group consisting of a hyperlink, a uniform resource locator (URL), and hyper text transfer protocol (HTTP) code.

25. The method of claim 2, wherein the third data processing device is connected to the first data processing device through a wireless network.

26. The method of claim 2, wherein the third data processing device is connected to the second data processing device through an internet connection.

27. A system for transferring a file to a second data processing device by means of a third data processing device, the system comprising:
a first data processing device operable to be in communication with the second data processing device using a communication program, and
a computer program operable to transfer the file from the first data processing device to the third data processing device,
wherein said computer program is operable to transmit a reference from the first data processing device to the second data processing device using the communication program, and
wherein the file on the third data processing device may be accessed from the second data processing device using said reference.

28. The system of claim 27, wherein the communication program is an instant messaging program.

29. The system of claim 28, wherein said instant messaging program is one from the group consisting of MSN Messenger, AOL Instant Messenger (AIM), Yahoo! Messenger and ICQ.

30. The system of claim 28, wherein the system further comprises a means for transmitting an instant message from the first data processing device to the second data processing device using said instant messaging program, wherein said instant message comprises said reference.

31. The system of claim 28, wherein the system further comprises a means for selecting a contact from a list stored in said instant messaging program.

32. The system of claim 28, wherein said computer program creates said reference to the file.

33. The system of claim 28, wherein the system further comprises a means for transmitting said reference from the third data processing device to said computer program.

34. The system of claim 28, wherein the system further comprises an input device resident on the first data processing device to create the file.

35. The system of claim 34, wherein the input device is one selected from the group consisting of an audio input device, an image input device, and a video input device.

36. The system of claim 34, wherein the input device is one selected from the group consisting of a microphone, an image camera and a video camera.

37. The system of claim 28, wherein the file is a multimedia file.

38. The system of claim 28, wherein the file is one selected from the group consisting of an audio file, an image file, and a video file.

39. The system of claim 28, wherein the system further comprises a means for selecting a type of the file to be sent to the second data processing device.

40. The system of claim 28, wherein the type is one selected from the group consisting of an audio file, an image file, and a video file.

41. The system of claim 28, wherein the first data processing device is a mobile device.

42. The system of claim 41, wherein said mobile device is one selected from the group consisting of a mobile phone, a personal digital assistant (PDA), a hybrid mobile phone/PDA, a laptop, a tablet computer, a webpad, a handheld computer, and a wearable computer.

43. The system of claim 28, wherein said computer program is adapted to function with a device selected from the group consisting of a Symbian device, a Symbian Series 60 device, a Symbian UIQ device, a Microsoft Smartphone, a Microsoft Pocket PC device, a Palm OS 3.5+ device, a Java ME device, a J2ME device, a BREW device, and a WAP enabled device.

44. The system of claim 28, wherein said computer program further comprises support for push to talk over internet protocol (IP).

45. The system of claim 28, wherein said computer program further comprises support for picture messaging and camera support.

46. The system of claim 28, wherein said computer program further comprises multi-lingual Unicode support.

47. The system of claim 28, wherein said computer program further comprises support for concurrent connections to instant messaging services.

48. The system of claim 28, wherein said computer program further comprises support for multiple simultaneous conversations.

49. The system of claim 28, wherein said reference is one selected from the group consisting of a hyperlink, a uniform resource locator (URL), and hyper text transfer protocol (HTTP) code.

50. The system of claim 28, wherein the third data processing device is connected to the first data processing device through a wireless network.

51. The system of claim 28, wherein the third data processing device is connected to the second data processing device through an internet connection.
